(19) United States
(12) Patent Application Publication
(10) Pub. No.: US 2016/0063334 A1
(43) Pub. Date: Mar. 3, 2016

(54) IN-VEHICLE IMAGING DEVICE

(71) Applicant: ALPS ELECTRIC CO., LTD., Tokyo (JP)

(72) Inventor: Yuichi Yasuda, Miyagi-ken (JP)

(21) Appl. No.: 14/799,828

(22) Filed: Jul. 15, 2015

(30) Foreign Application Priority Data
Aug. 29, 2014 (JP) 2014-176148

(51) Int. Cl. G06K 9/00; B60R 1/00; H04N 5/235; H04N 7/18; G06T 7/00; H04N 9/04

(52) U.S. Cl. CPC G06K 9/00832; G06T 7/004; H04N 9/04; H04N 5/2353; H04N 7/183; H04N 5/2351; B60R 1/00; B60R 2300/8006

(57) ABSTRACT

The face image of a passenger is acquired by a camera set in a vehicle cabin, the positions of a pupil and corneal reflection light of the face image are detected, and a visual line direction is calculated from the pupil and the corneal reflection light. A condition for automatic exposure control is predetermined, and the exposure time (shutter time) of the camera is controlled in accordance with the exposure condition. In a driving interval in the sunny daytime, the reference time of image luminance for the automatic exposure control is shortened, thereby enabling to follow the fluctuation of luminance inside a vehicle. In a driving interval in a cloudy condition and a driving interval in the night-time, the reference time of image luminance for the automatic exposure control is lengthened, thereby keeping automatic exposure from responding to the light of headlights of an oncoming vehicle.

### CLAIM OF PRIORITY

This application claims benefit of priority to Japanese Patent Application No. 2014-176148 filed on Aug. 29, 2014, which is hereby incorporated by reference in its entirety.

### BACKGROUND

1. Field of the Disclosure

The present disclosure relates to an in-vehicle imaging device that is arranged inside a vehicle and acquires the image of both eyes, the image of the face, and so forth of a passenger.

2. Description of the Related Art

An invention relating to a pupil detection method is described in Japanese Unexamined Patent Application Publication No. 2008-246004.

In this pupil detection method, a light source for giving light to both the eyes of a person and a half mirror for splitting light to be image-captured are provided, one of two split rays of light is caused to transmit through a bandpass filter for causing a wavelength of 850 nm to transmit therethrough and acquired by a first image sensor, and another split ray of light is caused to transmit through a bandpass filter for causing a wavelength of 950 nm to transmit therethrough and acquired by a second image sensor.

In the first image sensor, it is possible to acquire a bright pupil image, and in the second image sensor, it is possible to acquire a dark pupil image. Therefore, it is possible to detect pupils from an image difference therebetween. In addition, in a case where corneal reflection exists within a pupil portion, it is possible to detect this corneal reflection from the dark pupil image and it is possible to detect a visual line from the image of the pupil portion and the image of the corneal reflection. In this invention, since the bright pupil image and the dark pupil image are obtained in a state of turning on the same light source, it is possible to acquire the bright pupil image and the dark pupil image while keeping timings in synchronization.

In addition, in this type of pupil detection method, in some cases it is difficult to correctly acquire a face image, owing to a surrounding light environment such as sunlight, and in some cases it is difficult to correctly detect the corneal reflection. Therefore, in the pupil detection method described in Japanese Unexamined Patent Application Publication No. 2008-246004, in addition to the bright pupil image and the dark pupil image, a non-illuminated image is acquired and the influence of the surrounding light environment is reduced by subtracting the non-illuminated image from the bright pupil image and the dark pupil image, thereby intending to only extract bright and dark portions produced by illumination based on light emitted from the light source.

While it is considered that the pupil detection method described in Japanese Unexamined Patent Application Publication No. 2008-246004 is insusceptible to the surrounding light environment, it is necessary to use a special camera that utilizes the half mirror and the two image sensors and the structure thereof becomes complex. In addition, since, in addition to the bright pupil image and the dark pupil image, it is necessary to obtain the non-illuminated image, the setting of the acquisition timing of an image or the like becomes difficult.

In addition, while this type of pupil detection method is applied inside a vehicle, an outside light state outside the vehicle intricately varies with time. For example, in daytime driving in a fine day, the amount of light of outside light entering the vehicle is large and the inside of the vehicle becomes extremely bright. However, even in the same daytime driving, in a case of a cloudy weather, the amount of outside light entering the vehicle is considerably reduced. Furthermore, in night-time running, the amount of light inside the vehicle is incomparably reduced, compared with daytime. Therefore, using only correction utilizing the non-illuminated image, it is difficult to follow the significant variation of the outside light outside the vehicle and it is difficult to continue acquiring correct images.

The present invention solves the problem of the related art and provides an in-vehicle imaging device capable of following a light environment inside a vehicle significantly varying owing to the driving time of the vehicle, a weather, or the like and capable of detecting an image in an adequate exposure state while using the same camera as that of the related art.

### SUMMARY

An in-vehicle imaging device includes a camera configured to image-capture an image including an eye of a passenger, and a control unit configured to process the image image-captured by the camera. The control unit includes an exposure control unit configured to automatically control exposure of the camera, an outside light state determining unit configured to determine an outside light state outside a vehicle, a storage unit configured to store therein a plurality of exposure control conditions, and a selection unit configured to select one of the exposure control conditions, based on a change in luminance of the outside light state, and in the exposure control unit, based on the selected exposure control condition, the exposure of the camera is automatically controlled.

### BRIEF DESCRIPTION OF THE DRAWINGS

FIG. 1 is a front view illustrating an example of arrangement of light sources and cameras in an in-vehicle imaging device of an embodiment of the present invention;

FIG. 2 is a circuit block diagram of the in-vehicle imaging device of the embodiment of the present invention;

FIG. 3 is a detailed block diagram illustrating details of an automatic exposure control device included in the circuit block diagram of FIG. 2;

FIGS. 4A to 4C are timing chart diagrams illustrating timings of image acquisition based on turn-on of the light sources and the cameras;

FIG. 5 is an explanatory diagram illustrating an example of variation of an outside light state outside a vehicle;

FIGS. 6A and 6B are explanatory diagrams each illustrating a positional relationship between a direction of a visual line of an eye of a person and the in-vehicle imaging device; and

FIGS. 7A and 7B are explanatory diagrams for calculating the direction of the visual line from a pupil center and the center of corneal reflection light.

### DESCRIPTION OF THE EXEMPLARY EMBODIMENTS

(Configuration of In-Vehicle Imaging Device)

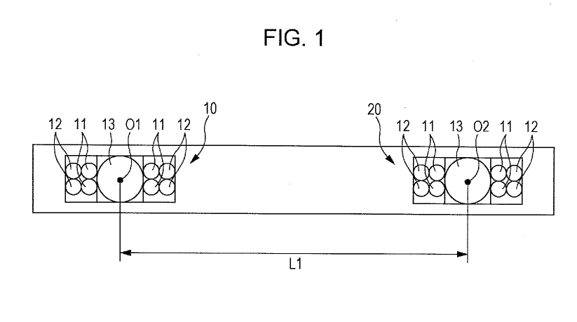

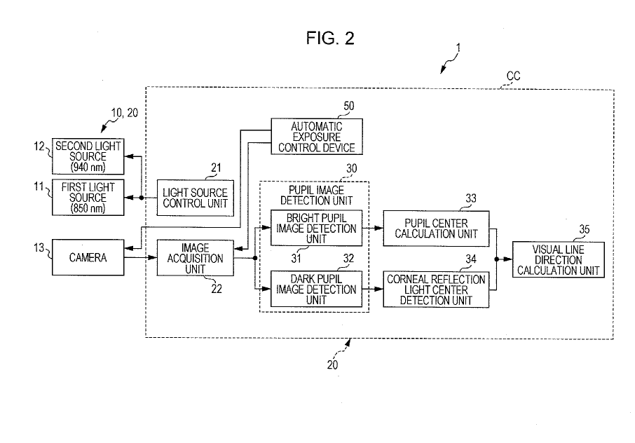

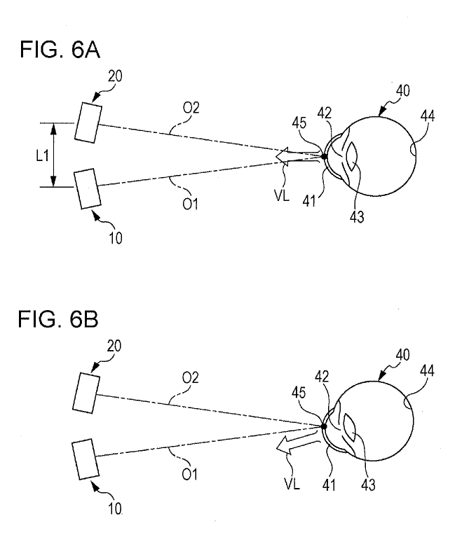

As illustrated in FIG. 2, an in-vehicle imaging device 1 of an embodiment of the present invention includes a pair of illuminating and image-capturing units 10 and 20 and a calculation control unit CC. As illustrated in FIG. 1 and FIGS. 6A and 6B, the illuminating and image-capturing unit 10 and the illuminating and image-capturing unit 20 are arranged a distance L1 away from each other. The distance L1 is set so as to be roughly equal to, for example, a distance between both eyes of a person.

The two illuminating and image-capturing units 10 and 20 each include a camera 13 and a plurality of first light sources 11 and a plurality of second light sources 12. The optical axis (the optical axis of the corresponding camera 13) of the illuminating and image-capturing unit 10 is O1, and the optical axis (the optical axis of the corresponding camera 13) of the illuminating and image-capturing unit 20 is O2. The light emission optical axes of the first light sources 11 are located near the optical axes O1 and O2, and the light emission optical axes of the second light sources 12 are located away from the light emission optical axes O1 and O2, compared with the first light sources 11.

FIGS. 6A and 6B each schematically illustrate the relative positions of the illuminating and image-capturing units 10 and 20 and an eye 40 of a person. The illuminating and image-capturing units 10 and 20 are installed in an instrument panel, the upper portion of a windshield, or the like, and both the optical axis O1 of the illuminating and image-capturing unit 10 and the optical axis O2 of the illuminating and image-capturing unit 20 are set so as to be directed at the vicinity of the eye 40 of the object person. While, in each of FIGS. 6A and 6B, the illuminating and image-capturing units 10 and 20 are described so as to only face the one eye, actually distances between the illuminating and image-capturing units 10 and 20 and a face are large and therefore it is possible to acquire the images of both eyes of the face of the person using the illuminating and image-capturing units 10 and 20.

The first light sources 11 and the second light sources 12 each include a light-emitting diode (LED). The first light sources 11 each emit, as sensing light, infrared light (near-infrared light) of a wavelength of 850 nm or a wavelength approximate thereto, and the second light sources 12 each emit infrared light of a wavelength of 940 nm.

The infrared light (near-infrared light) of the wavelength of 850 nm or a wavelength approximate thereto is poorly absorbed by water in an eyeball and the amount of light that reaches a retina located behind the eyeball and is reflected is increased. On the other hand, the infrared light of 940 nm is easily absorbed by water in the eyeball of an eye of a person. Therefore, the amount of light that reaches the retina located behind the eyeball and is reflected is decreased. In addition, as the sensing light, it is possible to use light of a wavelength other than 850 nm and 940 nm.

The cameras 13 each include an imaging element, a lens, and so forth. The imaging elements each include a complementary metal oxide semiconductor (CMOS), a charge-coupled device (CCD), or the like. The imaging elements each acquire, through the corresponding lens, a face image including an eye of a driver. In each of the imaging elements, light is detected by a plurality of two-dimensionally arranged pixels.

The calculation control unit CC includes a CPU and a memory in a computer, and in each of the blocks illustrated in FIG. 2, calculation is performed by executing preliminarily installed software.

In the calculation control unit CC, a light source control unit 21, an image acquisition unit 22, a pupil image detection unit 30, a pupil center calculation unit 33, a corneal reflection light center detection unit 34, and a visual line direction calculation unit 35 are provided.

In each of the illuminating and image-capturing units 10 and 20, the light source control unit 21 performs switching between light emission of the first light sources 11 and light emission of the second light sources 12, control of light emission time periods of the first light sources 11 and the second light sources 12, and so forth.

With respect to each frame, the image acquisition unit 22 acquires face images based on a stereo system, from two respective cameras (image capturing members) provided in the illuminating and image-capturing unit 10 and the illuminating and image-capturing unit 20. The images acquired by the image acquisition unit 22 are read into the pupil image detection unit 30 with respect to each frame. The pupil image detection unit 30 has the functions of a bright pupil image detection unit 31 and a dark pupil image detection unit 32. A bright pupil image is detected in the bright pupil image detection unit 31, a dark pupil image is acquired in the dark pupil image detection unit 32, and a difference between the bright pupil image and the dark pupil image may be calculated, thereby generating an image in which a pupil image is brightly displayed. In the pupil center calculation unit 33, the center of this pupil image is calculated, and the corneal reflection light center detection unit 34 extracts corneal reflection light from the dark pupil image and calculates the center position thereof. In addition, in the visual line direction detection unit 35, a visual line direction is calculated based on the pupil center and the corneal reflection light center.

The calculation control unit CC includes an automatic exposure control device 50. The automatic exposure control device 50 detects the luminance of the image of each frame acquired by the image acquisition unit 22 and automatically controls the exposure of each of the cameras 13. The control of the exposure of each of the cameras 13 mainly corresponds to control of an exposure time period (shutter time period) and control of an exposure gain.

(Bright Pupil and Dark Pupil)

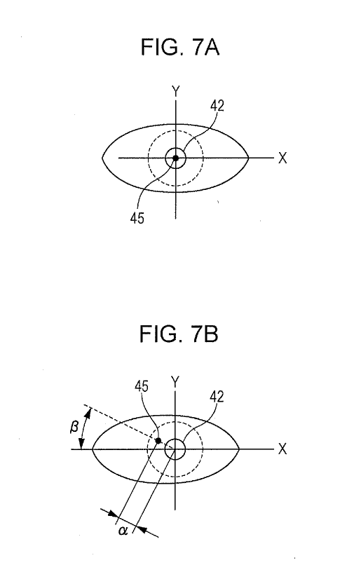

FIGS. 6A and 6B are plan views each schematically illustrating a relationship between the direction of the visual line of the eye 40 of the object person and the illuminating and image-capturing units 10 and 20. FIGS. 7A and 7B are explanatory diagrams for calculating the direction of the visual line from a pupil center and the center of corneal reflection light. FIG. 6A and FIG. 7A illustrate a state in which the visual line direction VL of the object person is directed at a portion located midway between the optical axis O1 of the illuminating and image-capturing unit 10 and the optical axis O2 of the illuminating and image-capturing unit 20, and FIG. 6B and FIG. 7B illustrate a state in which the visual line direction VL is directed in the direction of the optical axis O1.

The eye 40 includes a cornea 41 in front thereof, and a pupil 42 and a crystalline lens 43 are located posterior thereto. In addition, a retina 44 exists in a most posterior portion.

The sensing light whose wavelength is 850 nm reaches the retina 44 and is easily reflected. Therefore, when the first light sources 11 of the illuminating and image-capturing unit 10 are turned on, infrared light reflected from the retina 44 is detected through the pupil 42 and the pupil 42 appears bright, in an image acquired by the camera 13 provided in the same illuminating and image-capturing unit 10. This image is detected, as the bright pupil image, by the bright pupil image detection unit 31. In the same way, when the first light sources 11 of the illuminating and image-capturing unit 20 are turned on, infrared light reflected from the retina 44 is detected through the pupil 42 and the pupil 42 appears bright, in an image acquired by the camera 13 provided in the same illuminating and image-capturing unit 20.

In contrast, the sensing light whose wavelength is 940 nm is easily absorbed within the eyeball before reaching the retina 44. Therefore, in a case of each of the illuminating and image-capturing units 10 and 20, when the second light sources 12 are turned on, little infrared light is reflected from the retina 44 and the pupil 42 appears dark, in an image acquired by the camera 13. This image is detected, as the dark pupil image, by the dark pupil image detection unit 32.

On the other hand, each of the sensing light whose wavelength is 850 nm and the sensing light whose wavelength is 940 nm is reflected from the surface of the cornea 41 and the reflected light thereof is detected by both the bright pupil image detection unit 31 and the dark pupil image detection unit 32. Since in particular in the dark pupil image detection unit 32, the image of the pupil 42 is dark, reflected light reflected from the reflection point 45 of the cornea 41 is bright and detected as a spot image.

In the pupil image detection unit 30, a difference of the dark pupil image detected by the dark pupil image detection unit 32 may be obtained from the bright pupil image detected by the bright pupil image detection unit 31, and a pupil image signal in which the shape of the pupil 42 becomes bright may be generated. This pupil image signal is provided to the pupil center calculation unit 33. In the pupil center calculation unit 33, the center of the pupil 42 is calculated based on a method such as detecting the luminance distribution of a pupil image.

In addition, a dark pupil image signal detected in the dark pupil image detection unit 32 is provided to the corneal reflection light center detection unit 34. The dark pupil image signal includes a luminance signal base on the reflected light reflected from the reflection point 45 of the cornea 41. The reflected light from the reflection point 45 of the cornea 41 forms the image of a Purkinje image, and as illustrated in FIGS. 7A and 7B, the spot image whose area is quite small is acquired in the imaging element of each of the cameras 13. In the corneal reflection light center detection unit 34, the spot image is subjected to image processing, and from the luminance portion thereof, the center of a reflected spot image from the cornea 41 is obtained.

A pupil center calculation value calculated in the pupil center calculation unit 33 and a corneal reflection light center calculation value calculated in the corneal reflection light center detection unit 34 are provided to the visual line direction calculation unit 35. In the visual line direction calculation unit 35, the direction of the visual line is detected from the pupil center calculation value and the corneal reflection light center calculation value.

In FIG. 6A, the visual line direction VL of the eye 40 of the person is directed at a portion located midway between the two illuminating and image-capturing units 10 and 20. At this time, as illustrated in FIG. 7A, the center of the reflection point 45 from the cornea 41 coincides with the center of the pupil 42. In contrast, in FIG. 6B, the visual line direction VL of the eye 40 of the person is directed in the direction of the optical axis O1. At this time, as illustrated in FIG. 7B, the center of the reflection point 45 from the cornea 41 differs in position from the center of the pupil 42.

In the visual line direction calculation unit 35, a straight-line distance a between the center of the pupil 42 and the center of the reflection point 45 from the cornea 41 is calculated (FIG. 6B). In addition, X-Y coordinates with their origin at the center of the pupil 42 are set, and an inclination angle γ between a line connecting the center of the pupil 42 with the center of the reflection point 45 and an X-axis is calculated. From the straight-line distance a and the inclination angle γ, the visual line direction VL is calculated.

(Switching between Light Sources and Image-Capturing Timings)

Next, timings for switching between the turn-on of the first light sources 11 and the turn-on of the second light sources 12 and exposure timings based on the corresponding camera 13 will be described.

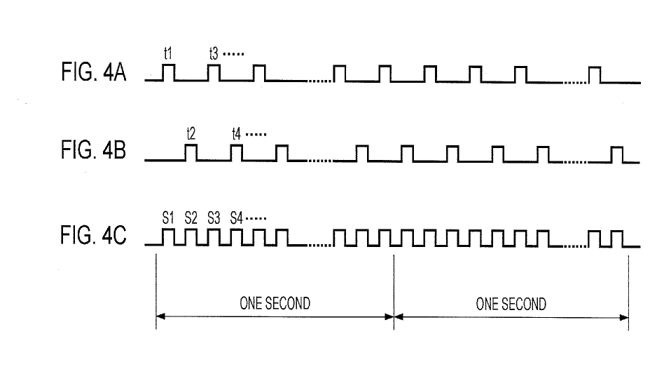

In FIGS. 4A to 4C, timings of switching between the turn-on of the light sources 11 the turn-on of the light sources 12 and an exposure timing based on the camera 13 in the illuminating and image-capturing unit 10 on one side are illustrated. FIG. 4A illustrates the turn-on timings of the first light sources 11 provided in the illuminating and image-capturing unit 10, and FIG. 4B illustrates the turn-on timings of the second light sources 12 provided in the illuminating and image-capturing unit 10. FIG. 4C illustrates exposure time periods (shutter time periods) based on the camera 13 provided in the illuminating and image-capturing unit 10.

In FIG. 4A, if the first light sources 11 are turned on at a timing t1, an image S1 to serve as the bright pupil image is acquired by the camera 13, and if the second light sources 12 are turned on at a timing t2, an image S2 to serve as the dark pupil image is acquired by the camera 13. After that, when the first light sources 11 are turned on at a timing t3, a bright pupil image S3 is acquired by the camera 13, and when the second light sources 12 are turned on at a timing t4, a dark pupil image S4 is acquired by the camera 13. Then, this is repeated.

At one exposure timing illustrated in FIG. 4C, an image corresponding to one frame is acquired. The number of frames (the number of images) per one second is about 30 to 60. Based on the number of images, it is possible to virtually recognize images image-captured by the camera 13 as moving images.

In the illuminating and image-capturing unit 20 on the other side, by setting the turn-on timings of the first light sources 11 and the second light sources 12 and the exposure timings of the camera 13, it is possible to acquire the bright pupil image and the dark pupil image.

The acquisition of the bright pupil image and the dark pupil image, based on the illuminating and image-capturing unit 10, and image-capturing for acquiring the bright pupil image and the dark pupil image, based on the illuminating and image-capturing unit 20, are alternately performed, and based on the stereo system utilizing the two cameras 13 and 13, the center of the pupil image and the center of corneal reflection light of each of both eyes are detected as pieces of data on three-dimensional coordinates.

(Automatic Exposure Adjustment)

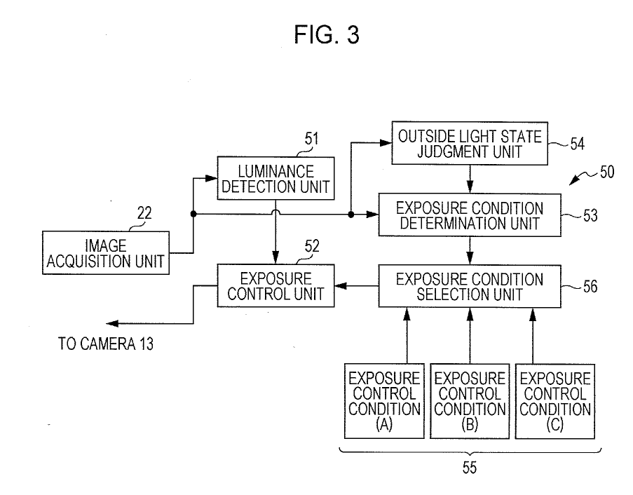

FIG. 3 illustrates the details of the automatic exposure control device 50 included in the calculation control unit CC.

The automatic exposure control device 50 includes a luminance detection unit 51 and an exposure control unit 52. The luminance of an image for each frame acquired in the image acquisition unit 22 is detected in the luminance detection unit 51. In addition, based on the luminance of an image acquired therebefore, in the exposure control unit 52, the cameras 13 (and the image acquisition unit 22) may be each controlled so that an exposure state in image-capturing thereafter is optimized, and the exposure time period (shutter time period) and the exposure gain may be adjusted.

As illustrated in FIG. 3, the automatic exposure control device 50 includes an exposure condition determination unit 53 and an outside light state determining unit 54. An outside light state outside a running vehicle is judged by the outside light state determining unit 54. In addition, in the exposure condition determination unit 53, in accordance with the judged outside light state, it is determined what exposure condition is set in automatic exposure control performed in the exposure control unit 52.

Within an image that includes the face of a passenger and is acquired by the image acquisition unit 22, the outside light state determining unit 54 searches for, for example, a region showing a view outside the vehicle through a window, and a current outside light state may be judged from the luminance of the view outside the vehicle. Alternatively, in a case where a light sensing camera or an optical sensor is arranged on the outside of an automobile, the current outside light state may be judged from the light intensity of outside light detected by one of these. In addition, by referring to time using a clock, the outside light state may be determined by the outside light state determining unit 54. Based on the time, it is possible to judge whether in a morning time zone, in the daytime, at dark, or in the night time. Furthermore, using GPS or another piece of navigation information, the amount of light inside the vehicle may be estimated.

Using various types of determining unit, it is possible to judge the outside light state in a comprehensive manner. Using clock information together in a case where, from, for example, the luminance of a view seen from the window or the sensing output of the outside light sensing camera or the optical sensor, it is recognized that the outside light is extremely bright, it may be judged that it is the daytime and the weather is clear. In addition, if, based on the navigation information, it is possible to determine the driving direction of the vehicle when, based on the clock information, it is determined that it is time to get the rising sun or it is time to get the setting sun in a case where one of the above-mentioned units determines that the outside light state corresponds to the daytime in point of luminance, it may be judged whether or not a state in which the face under image capturing gets the rising sun or the setting sun (afternoon sun) occurs.

As illustrated in FIG. 3, a storage unit 55 is provided in the automatic exposure control device 50, and respective pieces of condition data for deciding an exposure control condition (A) to an exposure control condition (C) may be stored in the storage unit 55. In accordance with the outside light state outside the vehicle judged by the outside light state determining unit 54, the exposure condition determination unit 53 controls the exposure condition selection unit 56. Based on this control operation, the exposure condition selection unit 56 reads out one of pieces of condition data of the exposure control condition (A) to the exposure control condition (C) from the storage unit 55 and provided the piece of condition data to the exposure control unit 52.

Hereinafter, automatic exposure control executed in the exposure control unit 52 will be described.

In the automatic exposure control, in the luminance detection unit 51, during a previous predetermined reference time period Tx (for example, about 1 to 10 seconds), the average value of the luminance, the peak value of the luminance, the standard deviation of the luminance, or the like of the image of each frame acquired by the image acquisition unit 22 may be obtained as a luminance measurement value. In the exposure control unit 52, the luminance of an image considered to be ideal, for example, an ideal value such as the average value of the luminance of an image or the distribution of an image for each pixel, is predetermined, and based on the above-mentioned luminance measurement value, the exposure time period (shutter time period) based on the corresponding camera 13 may be decided so that the luminance of an image to be image-captured thereafter becomes the above-mentioned ideal value or draws nigh to the ideal value. In addition, based on the measured luminance of a previously acquired image corresponding to one frame or the measured luminances of previously acquired images corresponding to several frames, the exposure gain may be simultaneously adjusted so that the luminance of an image to be image-captured thereafter becomes the ideal value or draws nigh to the ideal value.

The exposure control condition (A) to exposure control condition (C) recorded in the storage unit 55 may be pieces of condition data for deciding the above-mentioned reference time period Tx at the time of performing the automatic exposure control in the exposure control unit 52 and deciding whether or not to adjust the exposure gain.

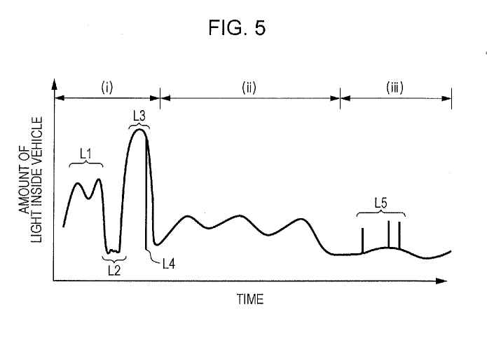

The exposure control condition (A) may be selected in a case where the outside light state outside the vehicle corresponds to a clear state in the daytime, in the outside light state determining unit 54. In FIG. 5, a horizontal axis illustrates time, and a vertical axis illustrates the amount (light intensity) of light entering the vehicle. An interval (i) in FIG. 5 illustrates an example of a change in the amount of light inside the vehicle at the time of the clear state in the daytime. While, in the clear state in the daytime, the amount of light entering the vehicle is large, the amount of light entering the vehicle widely fluctuates in accordance with a location where the vehicle moves. In the example of the interval (i) illustrated in FIG. 5, the amount of light inside the vehicle when the vehicle drives through the shade of a tree is L1, the amount of light inside the vehicle when the vehicle drives through a tunnel is L2, and the amount of light inside the vehicle when the vehicle drives through a location with lots of sunlight is L3. The amount L4 of light inside the vehicle indicates a state in which the amount of light inside the vehicle is reduced for a short time period in such a manner as at the time of driving under a girder.

In this way, at the time of daytime driving in a fine day, the fluctuation range of the intensity of light inside the vehicle is large and the number of components that cause the amount of light inside the vehicle to fluctuate is increased.

Therefore, in the exposure control condition (A), the above-mentioned reference time period Tx may be set to be short, and, for example, one second illustrated in FIGS. 4A to 4C may be set as the reference time period Tx. The average value of the luminance, the peak value of the luminance, the standard deviation of the luminance, or the like of the image of each frame detected by the luminance detection unit 51 during one second is obtained as the luminance measurement value. In addition, in the exposure control unit 52, based on the luminance measurement value obtained during one second, the exposure time period (shutter time period) based on the corresponding camera 13 may be decided so that the luminance of an image to be image-captured thereafter becomes the ideal value or draws nigh to the ideal value. Furthermore, in the exposure control condition (A), the condition may be decided so that, based on the measured luminance of a previously acquired image corresponding to one frame (or the measured luminances of previously acquired images corresponding to frames), the exposure gain is simultaneously adjusted so that the luminance of an image to be image-captured thereafter becomes the ideal value.

In this way, the reference time period (sampling time) Tx for automatically controlling the exposure time period may be shortened and furthermore, based on the sampling of the luminance of one frame or several frames, the exposure gain may be adjusted. Accordingly, even in a case where a change in the amount of light inside the vehicle is rapid and the fluctuation range thereof is large, a face image with optimum luminance may be acquired, and as a result, the bright pupil image and the dark pupil image may be accurately sensed and reflected light from a cornea may be stably acquired.

In a case where the outside light state determining unit 54 judges that the outside light state outside the vehicle is that it is the daytime and the weather is cloudy, the exposure control condition (B) may be selected. An interval (ii) in FIG. 5 illustrates an example of a change in the amount of light inside the vehicle when it is the cloudy daytime. In a case where the weather is cloudy even though the outside light state corresponds to the daytime, the peak value of the amount of light inside the vehicle is low and the fluctuation of the amount of light corresponding to a driving condition is moderate.

Therefore, in the exposure control condition (B), the above-mentioned reference time period Tx may be set to be slightly long, and, for example, two seconds (or three seconds) illustrated in FIGS. 4A to 4C may be set as the reference time period Tx. In addition, the exposure gain may be set to a fixed value. In other words, the average value of the luminance, the peak value of the luminance, the standard deviation of the luminance, or the like of the image of each frame detected by the luminance detection unit 51 during two seconds or three seconds is obtained as the luminance measurement value. In addition, in the exposure control unit 52, based on this luminance measurement value, the exposure time period (shutter time period) based on the corresponding camera 13 may be decided so that the luminance of an image to be image-captured thereafter becomes the ideal value or draws nigh to the ideal value.

In a case where it is cloudy even in the daytime, the fluctuation of the amount of light inside the vehicle is moderate. Therefore, in the exposure control unit 52, based on the moderate fluctuation of the amount of light inside the vehicle, it is possible to change the exposure time period. Since there is no extreme change in the exposure time period, it becomes possible to stably obtain the face image with optimum luminance.

In a case where the outside light state determining unit 54 judges that the outside light state outside the vehicle is the night-time, the exposure control condition (C) may be elected. An interval (iii) in FIG. 5 illustrates an example of a change in the amount of light inside the vehicle at the time of driving in the night-time. While, in night-time driving, the peak value of the amount of light inside the vehicle is low and does not widely fluctuate during driving, a case where the amount of light inside the vehicle instantaneously becomes high as illustrated by L5 frequently occurs owing to, for example, the irradiation of headlights at the time of going by an oncoming vehicle.

Therefore, in the exposure control condition (C), the above-mentioned reference time period Tx may be set to be further long, and, for example, about 5 seconds to 10 seconds may be set as the reference time period Tx. In addition, the exposure gain may be set to a fixed value. In other words, the average value of the luminance, the peak value of the luminance, the standard deviation of the luminance, or the like of the image of each frame detected by the luminance detection unit 51 during 5 seconds to 10 seconds is obtained as the luminance measurement value. In addition, in the exposure control unit 52, based on this luminance measurement value, the exposure time period (shutter time period) based on the corresponding camera 13 may be decided so that the luminance of an image to be image-captured thereafter becomes the ideal value or draws nigh to the ideal value.

By lengthening the reference time period in this way, it becomes possible to prevent the change L5 in the amount of light inside the vehicle, which instantaneously becomes high in such a manner as at the time of being under the headlights of an oncoming vehicle, to influence the automatic exposure control.

In addition, the exposure control conditions (A), (B), and (C) are examples, and an exposure control condition may be more finely decided. For example, a condition that, in a case where the face gets the rising sun or the setting sun (afternoon sun), the reference time period Tx is set to about 0.5 seconds and furthermore the exposure gain is controlled for the reference luminance of one frame may be set.

(Example of Modification)

In addition, the above-mentioned embodiment is described under the assumption that the bright pupil image is obtained at the time of turning on the first light sources 11 and the dark pupil image is obtained at the time of turning on the second light sources 12. In this regard, however, in another embodiment of the present invention, the first light sources 11 of the illuminating and image-capturing unit 10 and the first light sources 11 of the illuminating and image-capturing unit 20 are alternately turned on, and when the first light sources 11 of one of the illuminating and image-capturing units 10 and 20 are turned on, face images are simultaneously acquired by the camera 13 of the illuminating and image-capturing unit 10 and the camera 13 of the illuminating and image-capturing unit 20, thereby enabling the bright pupil image and the dark pupil image to be acquired.

If, for example, the first light sources 11 of the illuminating and image-capturing unit 10 are turned on and a face image is image-captured by the camera 13 of the illuminating and image-capturing unit 10, light from the first light sources 11 is reflected from the retina 44 and easily returns to the camera 13. Therefore, it is possible to acquire the bright pupil image. On the other hand, in a case where the first light sources 11 of the illuminating and image-capturing unit 10 are turned on, in the camera 13 of the illuminating and image-capturing unit 20, the image-capturing optical axis O2 thereof is located away from the optical axis of emitted light. Therefore, the dark pupil image is acquired.

In other words, in a case where the first light sources 11 of the illuminating and image-capturing unit 10 are turned on, the bright pupil image is acquired by the camera 13 of the illuminating and image-capturing unit 10 and the dark pupil image is acquired by the camera 13 of the illuminating and image-capturing unit 20. In a case where the first light sources 11 of the illuminating and image-capturing unit 20 on the other side are turned on, the dark pupil image is acquired by the camera 13 of the illuminating and image-capturing unit 10 and the bright pupil image is acquired by the camera 13 of the illuminating and image-capturing unit 20.

In this method, by detecting the luminances of the bright pupil image and the dark pupil image, it is possible to optimally set an image-capturing condition in the same way as in the above-mentioned embodiment.

What is claimed is:

1. An in-vehicle imaging device comprising: a camera configured to image-capture an image including an eye of a passenger: and a control unit configured to process the image image-captured by the camera, wherein
the control unit includes an exposure control unit configured to automatically control exposure of the camera, an outside light state determining unit configured to determine an outside light state outside a vehicle, a storage unit configured to store therein a plurality of exposure control conditions, and a selection unit configured to select one of the exposure control conditions, based on a change in luminance of the outside light state, and
in the exposure control unit, based on the selected exposure control condition, the exposure of the camera is automatically controlled.

2. The in-vehicle imaging device according to claim 1, wherein
the exposure control conditions include a condition selected in a case where the outside light state is determined as sunny daytime, a condition selected in a case where the outside light state is determined as cloudy daytime, and a condition selected in a case where the outside light state is determined as night-time.

3. The in-vehicle imaging device according to claim 1, wherein
the exposure control conditions are used for automatically controlling exposure in accordance with a luminance level of an image during a previous time period and the time period is set to become long as the outside light state becomes dark.

4. The in-vehicle imaging device according to claim 3, wherein
in an exposure control condition selected in a case where the outside light state is bright, an exposure gain is automatically controlled in accordance with luminance of an image of a previous frame.

5. The in-vehicle imaging device according to claim 1, wherein
in the outside light state determining unit, the outside light state is determined from luminance of a view outside the vehicle, included in an image acquired by the camera.

6. The in-vehicle imaging device according to claim 1, wherein
in the outside light state determining unit, the outside light state is determined from luminance of an image acquired by one of an outside light sensing camera or an optical sensor provided outside the vehicle.

7. The in-vehicle imaging device according to claim 5, wherein
in the outside light state determining unit, a GPS signal is used for determining the outside light state.

8. The in-vehicle imaging device according to claim 5, wherein
in the outside light state determining unit, clock information is used for determining the outside light state.

9. The in-vehicle imaging device according to claim 1, wherein
a bright pupil image and a dark pupil image of the image including the eye are image-captured by the camera and a pupil image is detected from a difference image between the bright pupil image and the dark pupil image.
